(19) United States
(12) Patent Application Publication
(10) Pub. No.: US 2024/0157864 A1
(43) Pub. Date: May 16, 2024

(54) VEHICLE FLOOR MAT FIXTURE

(71) Applicant: DAEHAN SOLUTION CO., LTD, Incheon (KR)

(72) Inventors: Choong Ho KWON, Seoul (KR); Jun-Ho PARK, Incheon (KR)

(73) Assignee: DAEHAN SOLUTION CO., LTD, Incheon (KR)

(21) Appl. No.: 18/385,967

(22) Filed: Nov. 1, 2023

(30) Foreign Application Priority Data
Nov. 14, 2022 (KR) 10-2022-0151250

(51) Int. Cl. B60N 3/04

(52) U.S. Cl. CPC B60N 3/046

(57) ABSTRACT

The present invention is provided so that a hooking operation is performed using a magnetic force of a permanent magnet when a floor mat is hooked on a hooking protrusion formed to protrude, and thus the floor mat can be mounted on a floor carpet to easily safely use the floor mat using a small force. In addition, as the present invention includes an upper member and a lower member so that the upper member finish is performed to prevent a carpet clip from being visible, the carpet clip is not exposed to a vehicle interior when the floor mat is installed to improve aesthetics and appearance of the vehicle interior. In addition, as the present invention is provided so that floor carpet is disposed between a pressing member and a base of the carpet clip to forcibly fix the carpet, the floor mat is stably fixedly supported and conveniently used in a state in which the carpet clip is firmly fixed to the floor carpet.

### CROSS-REFERENCE TO RELATED APPLICATION

This application claims priority to and the benefit of Korean Patent Application No. 10-2022-0151250, filed on Nov. 14, 2022, the disclosure of which is incorporated herein by reference in its entirety.

### BACKGROUND

### 1. Field of the Invention

The present invention relates to a vehicle floor mat fixture, and more specifically, to a vehicle floor mat fixture in which, when a floor mat is hooked on a carpet clip fixed to a floor carpet, the floor mat is attached to the carpet clip using a magnetic force of a permanent magnet to minimize exposure of a mounting portion for mounting the floor mat to the outside and improve aesthetics and appearance and is also easily conveniently fixed to a carpet mat using the magnetic force with only an operation of hooking the floor mat on the carpet clip to improve assembly efficiency.

### 2. Discussion of Related Art

Generally, a floor carpet is mounted on a floor panel of a vehicle to increase noise reduction performance in a vehicle interior. In addition, a floor mat is mounted on the floor carpet so that a driver and a passenger may safely use the floor carpet without slipping even when they put their feet on the floor carpet and the floor mat is also not contaminated to maintain a comfortable indoor environment.

Meanwhile, the floor mat is hooked on clips mounted in advance on the floor carpet and used, and such clips are manufactured and used in various forms as illustrated in Patent Document 1 to Patent Document 3 below.

(Patent Document 1) Korean Patent Registration No. 10-1881324

As pressing protrusions are formed to protrude from surfaces of a base and a pressing portion, which face each other and of which the pressing protrusions alternate and intersect, and a floor carpet is fitted between the pressing protrusions engaging with and intersecting each other, a floor mat fixture can be more firmly fixed to the floor carpet using the engagement and intersection while a fixing area is increased. In particular, when the pressing protrusions are formed on the surfaces of the base and the pressing portion which face each other, as the pressing protrusions are formed on the base and the pressing portion with which the floor carpet or a board is not in contact, a force applied by the pressing protrusions is added to an existing mounting force applied when the base and the pressing portion are fixed to the floor carpet, and thus the floor mat fixture can be more firmly fixed to the floor carpet.

(Patent Document 2) Korean Patent Registration No. 10-2290211

As a base and a fixing member are formed to face and be engaged with each other and a hooking protrusion is caught on and double assembled with the fixing member when a through protrusion formed on the fixing member passes through and is assembled with a floor carpet and the base, a floor mat hook can be firmly fixed to the floor mat not to be departed or separated, and thus the floor carpet can be used safely. In particular, as at least one pressing protrusion is formed on a surface of the base facing the floor carpet, when the floor mat hook is assembled, the pressing protrusion is more firmly fixed while being mounted on the floor carpet. In addition, as the base and the fixing member are integrally formed to be connected through a soft portion, the vehicle floor mat hook may be injection molded at once, and thus the vehicle floor mat hook can be easily manufactured and used conveniently and firmly fixed to the floor carpet.

(Patent Document 3) Korean Patent Registration No. 10-1908027

A vehicle floor mat fixture in which, as pressing protrusions are formed to protrude from surfaces of a base and a pressing portion, which face each other and of which the pressing protrusions alternate, and a floor carpet is fitted between the pressing protrusions engaging with each other, a floor mat fixture can be more firmly fixed to the floor carpet using the engagement while a fixing area is increased, is provided. In particular, a vehicle floor mat fixture in which, when pressing protrusions are formed on surfaces of a base and a pressing portion which face each other, as the pressing protrusions are formed on the base and the pressing portion with which a floor carpet or a board is not in contact, a force applied by the pressing protrusions is added to an existing mounting force applied when the base and the pressing portion are fixed to the floor carpet, and thus a vehicle floor mat fixture which is more firmly fixed to the floor carpet, is provided.

### RELATED ART

### Patent Document

(Patent Document 1) Korean Patent Registration No. 10-1881324 (Registration Date: Jul. 18, 2018)
(Patent Document 2) Korean Patent Registration No. 10-2290211 (Registration Date: Aug. 10, 2021)
(Patent Document 3) Korean Patent Registration No. 10-1908027 (Registration Date: Oct. 8, 2018)

### SUMMARY OF THE INVENTION

Meanwhile, as illustrated in FIGS. 1 and 2, since such a conventional floor mat M is hooked on and fixed to a hooking protrusion P formed on a clip F mounted on a floor carpet C, the following problems occur.

(1) Generally, since one floor mat is hooked on and fixed to at least four clips, in a state in which any one side of the floor mat is hooked on the clip, the floor mat should be pulled using a certain magnitude of strong force to be hooked on the other side on the clip.

(2) Since the floor mat should be separated from and reassembled with a floor carpet to wash a mat or clean the floor carpet, when the floor mat of which one side is hooked may not be pulled sufficiently, it is difficult to separate the floor mat from the floor carpet.

(3) When positions of the clips are adjusted to hook the floor mat using a small force to solve such problems, the floor mat may be easily separated or assembled, and when a driver and a passenger pushes the floor mat using feet, the floor mat may be easily separated from the floor carpet.

(4) Accordingly, when the floor mat is separated from the floor carpet while the driver is driving, the separated floor mat may be fitted between a brake pedal and an accelerator pedal to cause an accident.

(5) In addition, since it is dangerous to fit the floor mat separated from the floor carpet to the floor carpet in its original state while driving, when the floor mat is not properly laid as described above, there is a concern that foreign matter or food attached to shoes may fall on the floor carpet and contaminate a vehicle interior.

The present invention is directed to providing a vehicle floor mat fixture in which, when a floor mat is hooked on a hooking protrusion formed to protrude, a hooking operation is performed using a magnetic force of a permanent magnet so that the floor mat is mounted on a floor carpet and conveniently and safely used using a small force.

In addition, the present invention is also directed to providing a vehicle floor mat fixture which includes an upper member and a lower member so that the upper member finish is performed so that a carpet clip is not visible and in which the carpet clip is not exposed to a vehicle interior when the floor mat is mounted to improve aesthetics and appearance of the vehicle interior.

In addition, the present invention is also directed to providing a vehicle floor mat fixture in which a floor carpet is disposed between a pressing member and a base of a carpet clip to forcibly fix the carpet clip to safely fixedly support and conveniently use the floor mat in a state in which the carpet clip is firmly fixed to the floor carpet.

According to an aspect of the present invention, there is provided a vehicle floor mat fixture comprising an upper member (200) and a lower member (300), which are installed in a mounting hole (H) formed in a floor mat (M) so that the floor mat (M) is hooked and mounted on a hooking protrusion (110) formed to protrude from one surface of a carpet clip (100) mounted on a floor carpet (C), and mounted on the floor carpet for a vehicle, wherein the upper member (200) is formed wider than the mounting hole (H) to finish the mounting hole (H), a column (210) which passes through and is fitted into the mounting hole (H) is formed in a center of the upper member (200) to surround the hooking protrusion (110), a second permanent magnet (211) is installed inside the column (210) to face a first permanent magnet (111) mounted on the hooking protrusion (110), an elastic step (212) is formed to protrude from an outer edge of the column (210), the lower member (300) is formed wider than the mounting hole (H) so that the hooking protrusion (110) is formed to pass through the lower member (300), a hooking step (310) is formed in a center of the lower member (300) to be partially fitted into the mounting hole (H) to a partial thickness of the mounting hole (H), and the elastic step (212) is hooked on the hooking step (310) while the column (210) is forcibly fitted to the hooking step (310).

In particular, the carpet clip (100) may include a base (100′) having a predetermined area, the hooking protrusion (110) formed to protrude from one surface of the base (100′) and having a protruding end portion on which the first permanent magnet (111) is mounted, a pressing member (120) integrally formed with the base (100′) on the other surface of the base (100′) to be rotated around a soft portion (121), passing through and fitted to the floor carpet (C), and having an end portion which protrudes outward and on which an elastic protrusion (122) is integrally formed, and a stopper (130) which is formed on a surface facing the elastic protrusion (122) and to which the elastic protrusion (122) is forcibly fitted to perform a hooking operation.

In this case, a pressing protrusion (140) may be formed to protrude from a surface of the carpet clip (100) in contact with the floor carpet (C).

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a set of perspective views of a floor mat mounted on a conventional floor carpet, wherein FIG. 1A shows a state in which the floor mat is mounted on the floor carpet, and FIG. 1B shows a state in which the floor mat is separated from the floor carpet;

FIG. 2 is a cross-sectional view of a state in which the floor mat is mounted on the conventional floor carpet;

FIG. 3 is a cross-sectional view of a state in which a floor mat is mounted on a floor carpet using a vehicle floor mat fixture according to the present invention;

FIG. 4 is a set of views of a structure of an upper member according to the present invention, wherein FIG. 4A is an exploded perspective view of a position at which the upper member is mounted on the floor mat, and FIG. 4B is a bottom perspective view of the upper member;

FIG. 5 is an exploded view of a position at which the lower member is mounted on the floor mat according to the present invention;

FIG. 6 is a set of exploded views of a state in which the lower member and the upper member face each other around the floor mat and are assembled into one according to the present invention, wherein FIG. 6A is a perspective view, and FIG. 6B is a cross-sectional view; and

FIG. 7 is a set of views of a state in which the floor mat is fixed to a carpet clip according to the present invention, wherein FIG. 7A is an exploded perspective view, and FIG. 7B is a cross-sectional view.

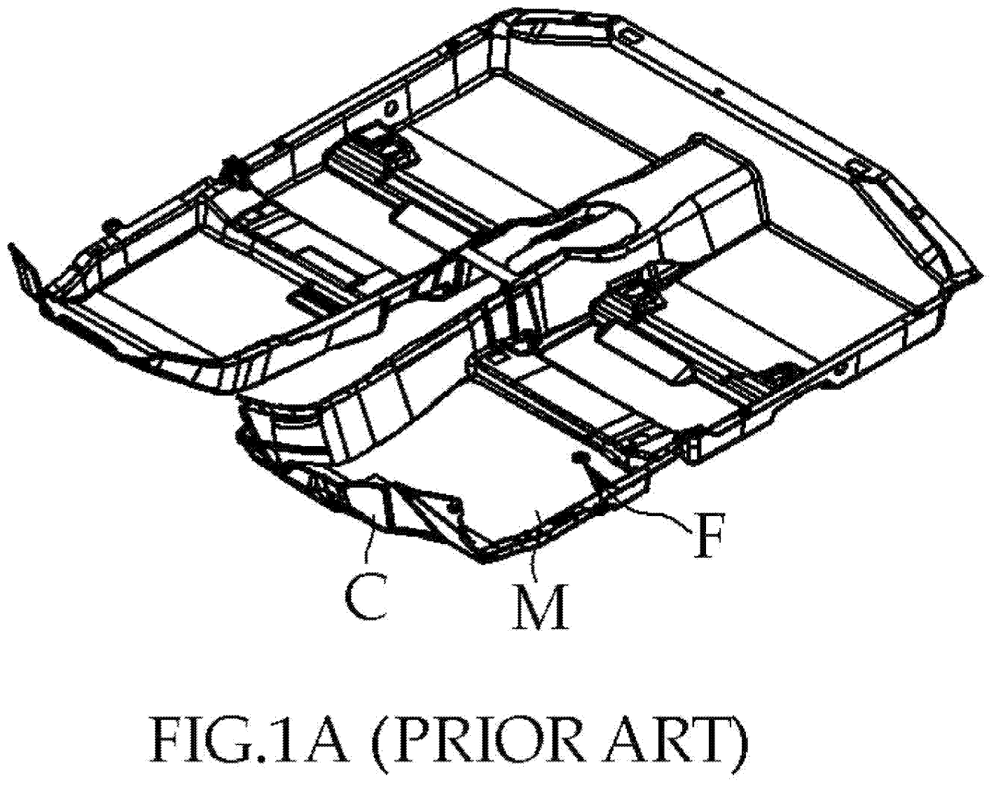

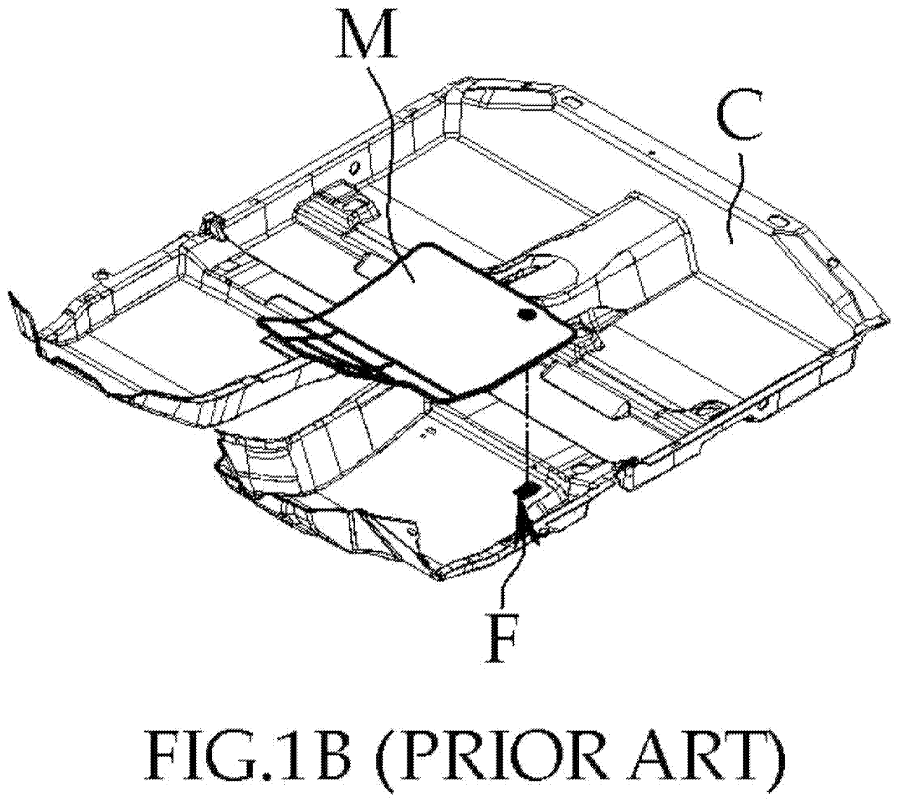

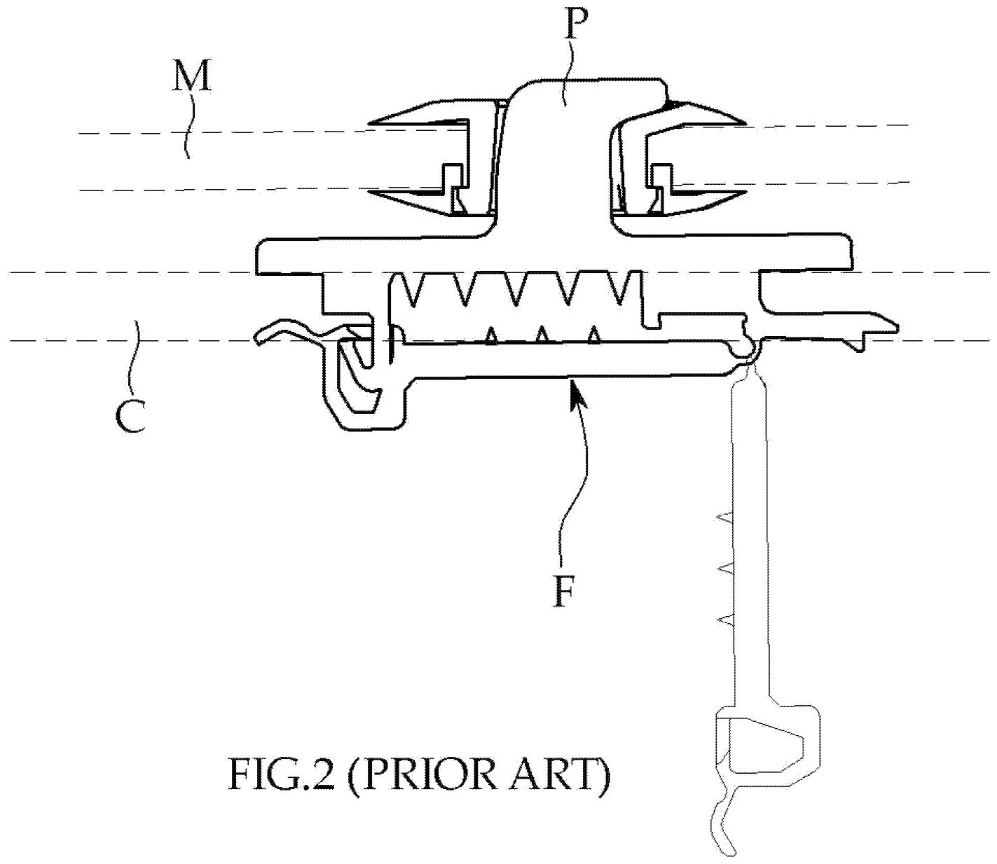

### DETAILED DESCRIPTION OF EXEMPLARY EMBODIMENTS

Hereinafter, exemplary embodiments of the present invention will be described in more detail with reference to the accompanying drawings. Moreover, terms and words used in the present specification and claims should not be interpreted as being limited to commonly used meanings or meanings in dictionaries and should be interpreted as having meanings and concepts which are consistent with the technological scope of the invention based on the principle that the inventors have appropriately defined concepts of terms in order to describe the invention in the best way.

Therefore, since the embodiments described in this specification and components illustrated in the drawings are only exemplary embodiments and do not represent the overall technological scope of the invention, it should be understood that there may be various equivalents or modifications substituting the exemplary embodiments at the time of filing of this application.

[Structure of Vehicle Floor Mat Fixture]

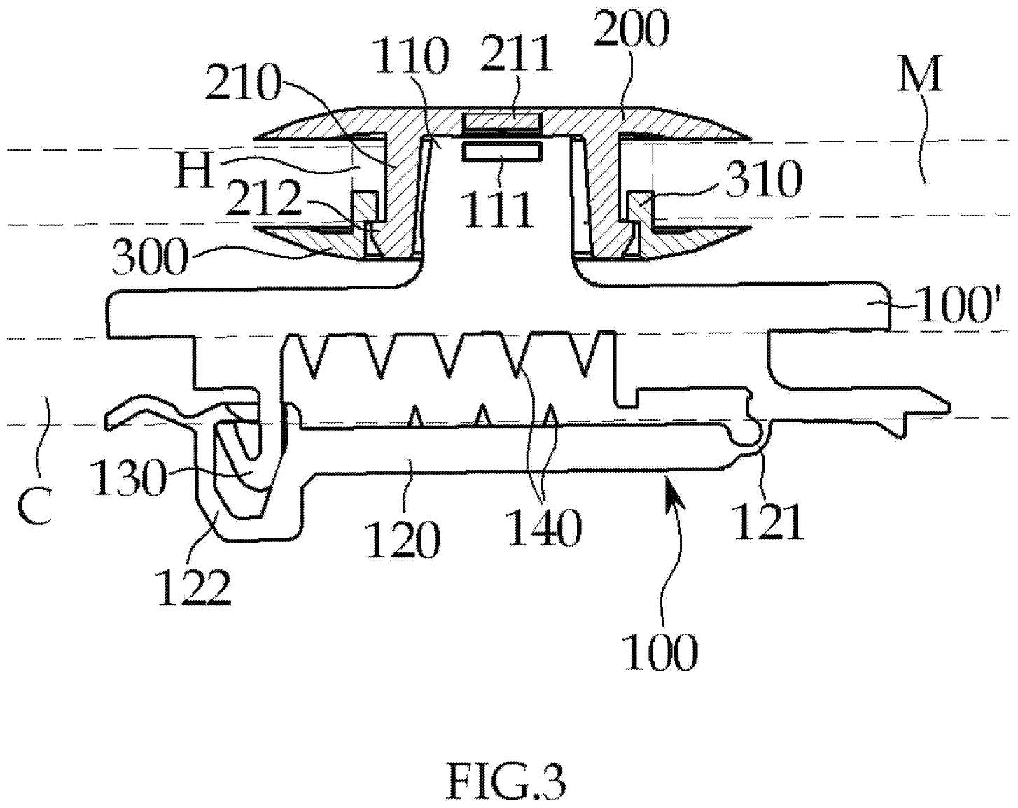

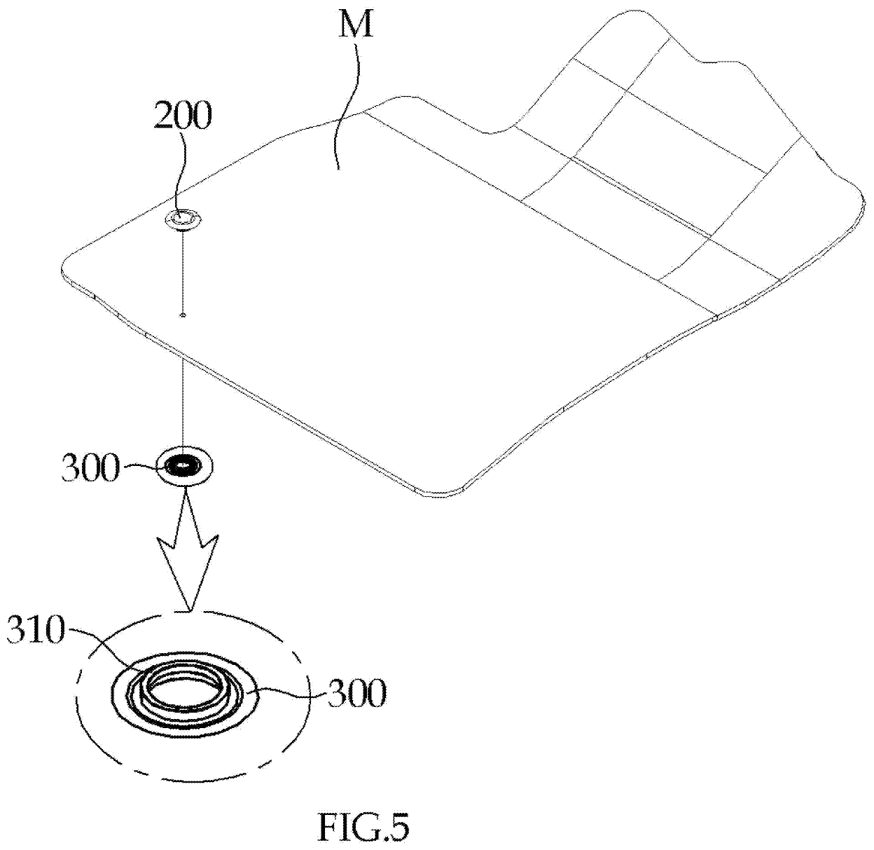

As illustrated in FIGS. 3 to 7, a vehicle floor mat fixture according to the present invention includes an upper member 200 and a lower member 300 which face each other through a mounting hole H formed in a floor mat M and are coupled into one.

In this case, a hooking protrusion 110 formed on a carpet clip 100 fixed to a floor carpet C passes through and is fitted into the lower member 300, and a first permanent magnet 111 formed in the hooking protrusion 110 is attached to a second permanent magnet 211 formed inside the upper member 200 so that the floor mat M can be easily conveniently mount on the floor carpet C to improve work efficiency.

In addition, as the upper member 200 surrounds the hooking protrusion 110 so that the hooking protrusion 110 is not exposed to a vehicle interior, foreign matter is prevented from being caught between the upper member 200 and the hooking protrusion 110, and aesthetics and appearance of the vehicle interior are also improved.

Hereinafter, such a structure will be described in more detail with reference to the accompanying drawings.

A. Carpet Clip

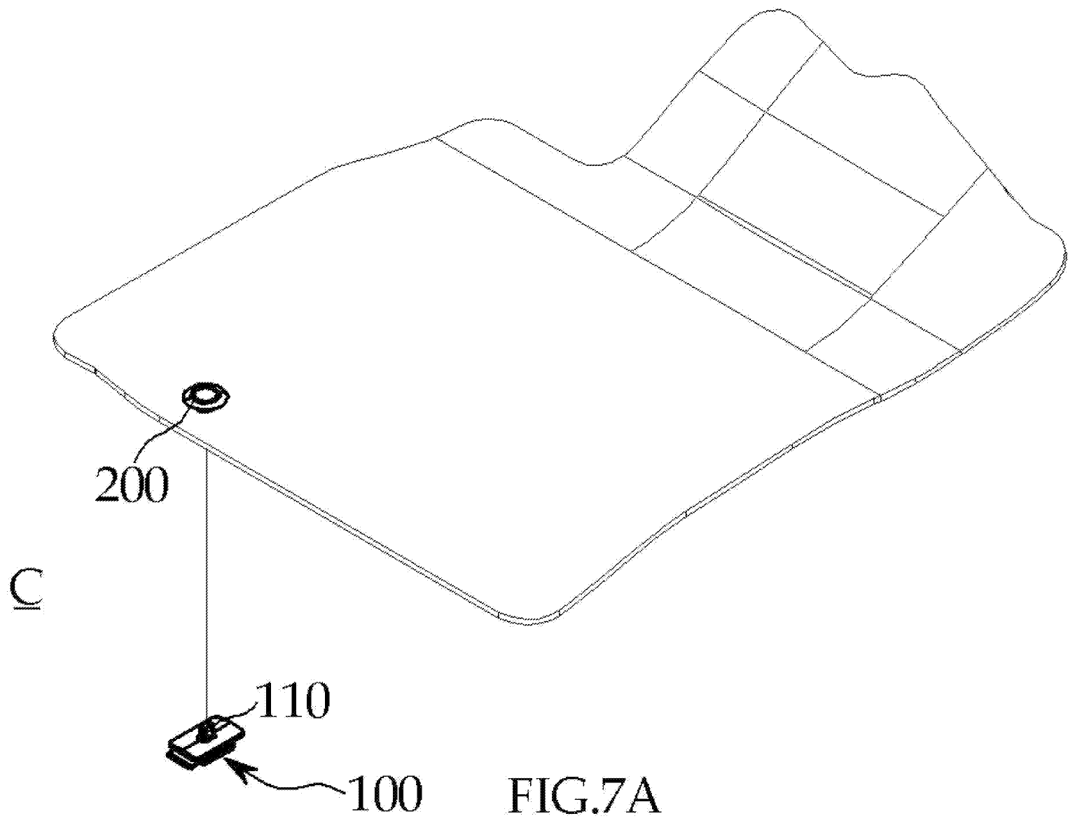

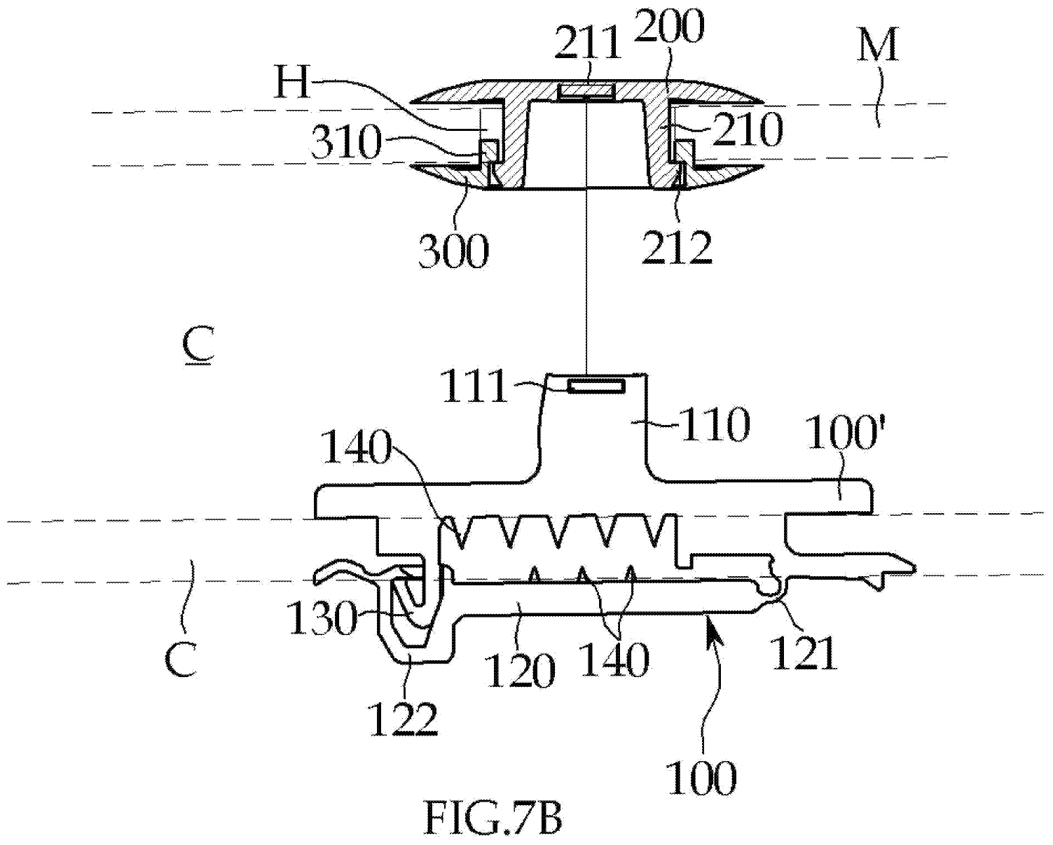

As illustrated in FIGS. 3 and 7, the carpet clip 100 is mounted on the floor carpet C in advance, and the floor mat M with which the upper member 200 and the lower member 300, which will be described below, are assembled is fixedly hooked on the carpet clip 100.

Accordingly, as illustrated in FIGS. 3 and 7, the carpet clip 100 includes a base 100′, the hooking protrusion 110, a pressing member 120, and a stopper 130. In addition, the carpet clip 100 may further include pressing protrusions 140 to firmly fix the carpet clip 100 to the floor carpet C.

1. Base

As illustrated in FIGS. 3 and 7, the base 100′ is manufactured to have a predetermined area. This is to prevent the carpet clip 100 from being separated from the floor carpet C by firmly pressing the base 100′ against a surface of the floor carpet C.

2. Hooking Protrusion

As illustrated in FIGS. 3 and 7, the hooking protrusion 110 is formed to protrude from one surface of the base 100′. In this case, the hooking protrusion 110 is fitted into the mounting hole H formed in the floor mat M, and the hooking protrusion 110 may be formed to have a length which does not protrude outward from the mounting hole H. This is to prevent the hooking protrusion 110 from protruding outward from the upper member 200 and also to minimize a gap between the base 100′ and the floor mat M when the upper member 200 and the lower member 300, which will be described below, are coupled to the mounting hole H and the hooking protrusion 110 is fitted into the mounting hole H.

Meanwhile, in the exemplary embodiment of the present invention, as illustrated in FIGS. 3 and 7, the first permanent magnet 111 is mounted on a protruding end portion of the hooking protrusion 110. As the hooking protrusion 110 is fitted into the upper member 200, which will be described below, the first permanent magnet 111 is attached to the second permanent magnet 211 installed inside the upper member 200 to fix the floor mat M to the floor carpet C.

3. Pressing Member

As illustrated in FIGS. 3 and 7, the pressing member 120 is integrally formed with the base 100′ to be rotated about a soft portion 121 on the other surface of the base 100′. In this case, the soft portion 121 is a portion which connects the base 100′ and the pressing member 120 and is formed to have a smaller thickness than other portions so that the pressing member 120 rotates about the soft portion 121 to be hooked on the stopper 130 which will be described below, and thus the floor carpet C is disposed between the base 100′ and the pressing member 120 to fix the carpet clip 100 to the floor carpet C.

As illustrated in FIGS. 3 and 7, the pressing member 120 passes through and is fitted to the floor carpet C, is rotated to face the base 100′, and then is fixedly hooked on the stopper 130 which will be described below. Accordingly, an elastic protrusion 122 which is elastically deformed to be hooked on and unhooked from the stopper 130 is formed on an end portion of the pressing member 120.

4. Stopper

As illustrated in FIGS. 3 and 7, the stopper 130 is formed on a surface of the base 100′ on which the pressing member 120 is formed. In this case, the stopper 130 may be formed at a position facing the elastic protrusion 122 to have an appropriate length in consideration of the floor carpet C which is fitted between the base 100′ and the pressing member 120. The stopper 130 may be manufactured through the conventional technology so that the elastic protrusion 122 is elastically deformed and restored to its original shape to perform a hooking operation and the elastic protrusion 122 in a hooked state is elastically deformed to enter an unhooked state.

5. Pressing Protrusion

As illustrated in FIGS. 3 and 7, in the carpet clip 100, the pressing protrusions 140 are formed on surfaces in contact with the floor carpet C, preferably surfaces of the base 100′ and pressing member 120. When the pressing member 120 passing through and fitted to the floor carpet C is rotated and hooked on and assembled with the stopper 130, the pressing protrusions 140 press the surfaces of the floor carpet C to more firmly mount the carpet clip 100 on the floor carpet C.

B. Upper Member

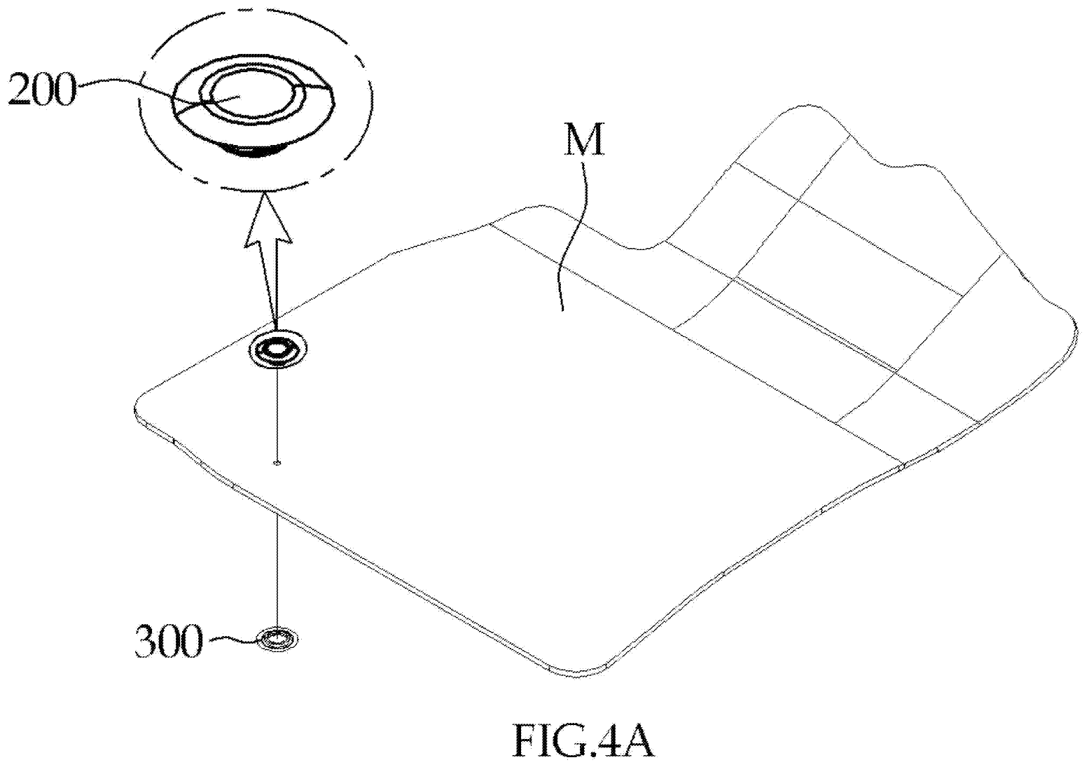

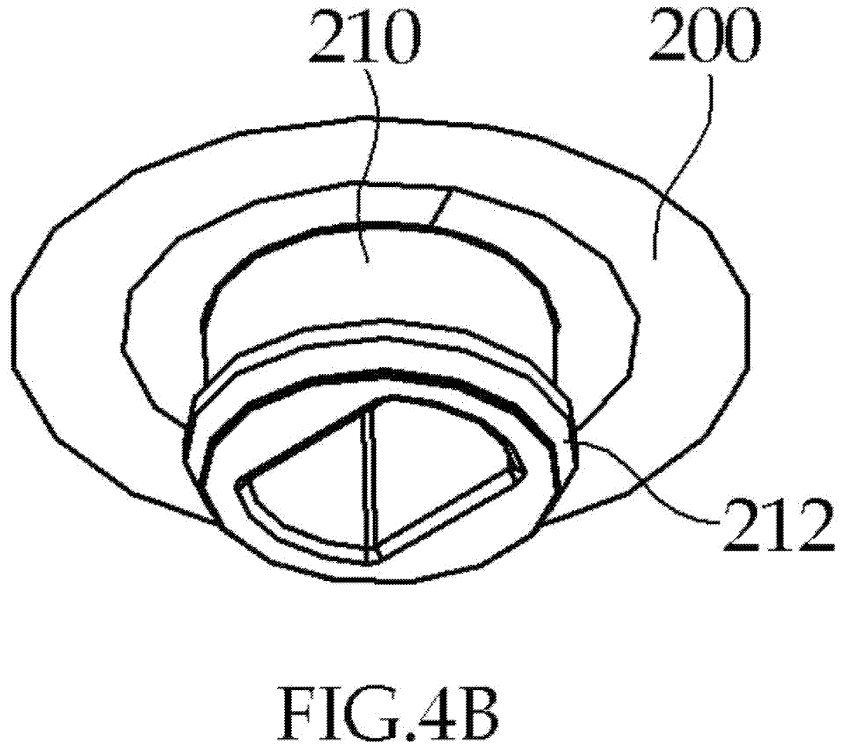

As illustrated in FIGS. 3 and 4, the upper member 200 is formed wider than the mounting hole H formed in the floor mat M. This is to finish the mounting hole H to hide the inside of the mounting hole H using the upper member 200 so as to minimize an exposed assembly portion to improve aesthetics and appearance when the upper member 200 is fitted into the mounting hole H.

As illustrated in FIGS. 3, 4, and 6, the upper member 200 includes a column 210.

Column

As illustrated in FIGS. 3, 4, and 6, the column 210 is formed to protrude outward from a center of the upper member 200. In this case, the column 210 is fitted into the mounting hole H and formed in a hollow cylindrical shape, and as illustrated in FIGS. 3 and 7, the hooking protrusion 110 is fitted into and assembled with the column 210.

In this case, as illustrated in FIGS. 3, 6, and 7, the second permanent magnet 211 is installed on an inner surface of the column 210 at a position facing the first permanent magnet 111 described above, and an elastic step 212 is formed to protrude from an end portion of an outer portion of the column 210 so that the column 210 is assembled with the lower member 300, which will be described below, into one using elasticity.

C. Lower Member

As illustrated in FIGS. 3, 5, and 7, the lower member 300 is formed wider than the mounting hole H, and the hooking protrusion 110 passes through and is fitted to a central portion of the lower member 300.

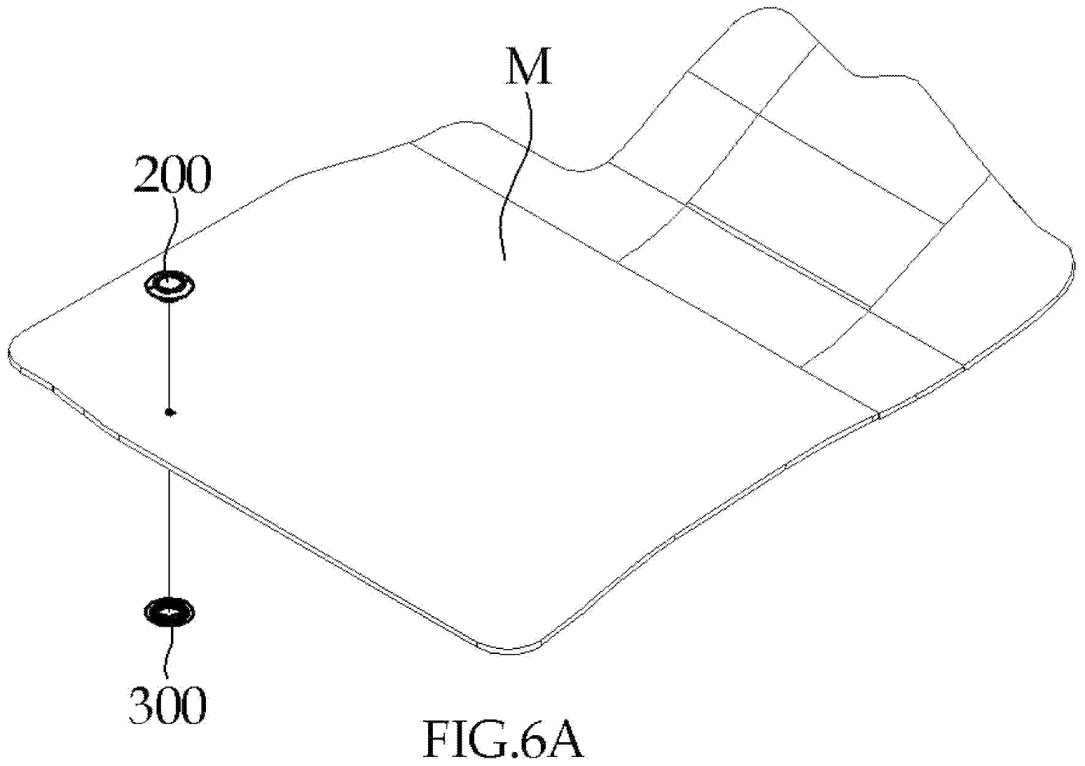

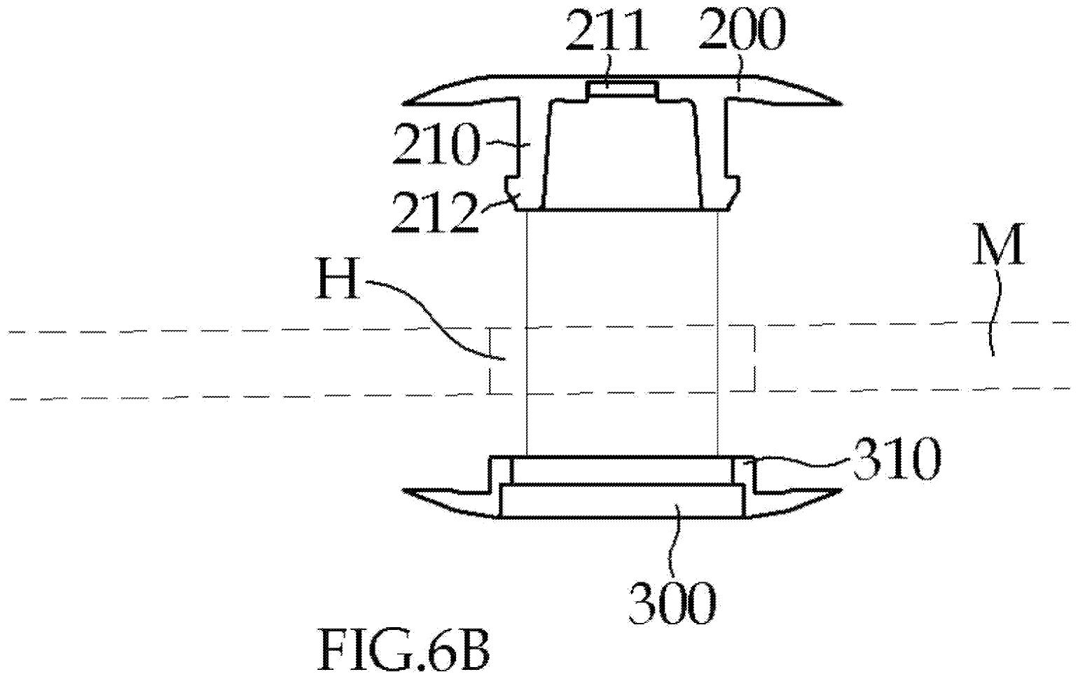

In addition, a hooking step 310 is formed on an edge portion of the lower member 300 to which the hooking protrusion 110 is fitted, and, as illustrated in FIG. 6, the upper member 200 and the lower member 300 are positioned on both sides of the mounting hole H of the floor mat M and assembled into one so that the elastic step 212 is hooked on the hooking step 310 and thus the upper member 200 and the lower member 300 are assembled into one.

In the present invention described above, as the upper member and the lower member face each other around the mounting hole and are integrally assembled, and then the hooking protrusion passes through and is fitted to the lower member to fix the floor mat using a magnetic force, not only the upper member and the lower member can be easily conveniently assembled using the permanent magnet, but the hooking protrusion portion is also not exposed to the outside to improve aesthetics and appearance.

A vehicle floor mat fixture according to the present invention has the following effects.

(1) Everyone can easily conveniently assemble a floor mat with a floor carpet by assembling an upper member and a lower member with a mounting hole which is formed in the floor mat and disposed between the upper member and the lower member and hooking the lower member on a carpet clip mounted on the floor carpet to fit the lower member to the carpet clip so that a permanent magnet provided on the upper member is in close contact with another permanent magnet provided on the carpet clip.

(2) As the floor carpet is mounted by hooking the lower member on the hooking protrusion of the carpet clip as described above, it is convenient not only to reduce a mounting time of the floor carpet but also to assemble the floor carpet easily.

(3) Meanwhile, as the upper member not only includes the permanent magnet but also is formed so that a hooking protrusion is not exposed to a vehicle interior, aesthetics and appearance of the floor carpet is improved to improve an indoor environment of the vehicle interior.

(4) In addition, as the lower member and the upper member are formed to face each other through the mounting hole and assembled with each other using elasticity when the lower member and the upper member are pressed, everyone can easily couple the upper member and the lower member and hook the upper member and the lower member on the hooking protrusion to fixedly support the floor carpet.

What is claimed is:

1. A vehicle floor mat fixture comprising an upper member (200) and a lower member (300), which are installed in a mounting hole (H) formed in a floor mat (M) so that the floor mat (M) is hooked and mounted on a hooking protrusion (110) formed to protrude from one surface of a carpet clip (100) mounted on a floor carpet (C), and mounted on the floor carpet for a vehicle,
wherein the upper member (200) is formed wider than the mounting hole (H) to finish the mounting hole (H),
a column (210) which passes through and is fitted into the mounting hole (H) is formed in a center of the upper member (200) to surround the hooking protrusion (110),
a second permanent magnet (211) is installed inside the column (210) to face a first permanent magnet (111) mounted on the hooking protrusion (110),
an elastic step (212) is formed to protrude from an outer edge of the column (210),
the lower member (300) is formed wider than the mounting hole (H) so that the hooking protrusion (110) is formed to pass through the lower member (300),
a hooking step (310) is formed in a center of the lower member (300) to be partially fitted into the mounting hole (H) to a partial thickness of the mounting hole (H), and
the elastic step (212) is hooked on the hooking step (310) while the column (210) is forcibly fitted to the hooking step (310).

2. The vehicle floor mat fixture of claim 1, wherein the carpet clip (100) includes:
a base (100′) having a predetermined area;
the hooking protrusion (110) formed to protrude from one surface of the base (100′) and having a protruding end portion on which the first permanent magnet (111) is mounted;
a pressing member (120) integrally formed with the base (100′) on the other surface of the base (100′) to be rotated around a soft portion (121), passing through and fitted to the floor carpet (C), and having an end portion which protrudes outward and on which an elastic protrusion (122) is integrally formed; and
a stopper (130) which is formed on a surface facing the elastic protrusion (122) and to which the elastic protrusion (122) is forcibly fitted to perform a hooking operation.

3. The vehicle floor mat fixture of claim 2, wherein a pressing protrusion (140) is formed to protrude from a surface of the carpet clip (100) in contact with the floor carpet (C).
